(19) United States
(12) Patent Application Publication
(10) Pub. No.: US 2016/0231982 A1
(43) Pub. Date: Aug. 11, 2016

(54) ACOUSTIC OUTPUT DEVICE AND CONTROL METHOD THEREOF

(71) Applicant: SAMSUNG ELECTRONICS CO., LTD., Suwon-si (KR)

(72) Inventors: Ji-gwang KIM, Seoul (KR); Joon-soo KIM, Seoul (KR)

(73) Assignee: SAMSUNG ELECTRONICS CO., LTD., Suwon-si (KR)

(21) Appl. No.: 15/016,679

(22) Filed: Feb. 5, 2016

(30) Foreign Application Priority Data
Feb. 5, 2015 (KR) 10-2015-0018158

(51) Int. Cl. G06F 3/16; G06F 3/0485; G06F 3/0482; H04R 1/02

(52) U.S. Cl. CPC G06F 3/165; H04R 1/028; G06F 3/0485; G06F 3/0482; H04R 2499/15

(57) ABSTRACT

An acoustic output device is provided. The acoustic output device includes: a speaker unit; a user interface unit providing a user interface region for browsing acoustic contents and a scroll user interface (UI) scrolled in the user interface region and guiding a position of an acoustic content selected depending on a scroll interaction in the user interface region to which all the acoustic contents are mapped; and a processor performing a control to decide or designate an acoustic content corresponding to a position of the scroll UI among all the acoustic contents mapped to the user interface region and output the decided acoustic content through the speaker unit. Therefore, a position of a virtual acoustic content is displayed and outputted according to a position of a user interface device depending on a manipulation of a user, such that manipulation convenience of the user is increased.

### CROSS-REFERENCE TO RELATED APPLICATIONS

This application claims priority from Korean Patent Application No. 10-2015-0018158, filed on Feb. 5, 2015, in the Korean Intellectual Property Office, the disclosure of which is incorporated herein by reference in its entirety.

### BACKGROUND

1. Field

Apparatuses and methods consistent with the embodiments relate to an acoustic output device and a control method thereof, and more particularly, to an acoustic output device capable of providing a user interface for selecting an acoustic content, and a control method thereof.

2. Description of the Related Art

In accordance with the development of an electronic technology, various types of electronic apparatuses have been developed and spread. Particularly, in relation to an acoustic output device for browsing digital acoustic contents, various user interface technologies for searching a desired content among a plurality of acoustic contents have been used.

However, in order to browse digital acoustic contents in the related art, a desired acoustic content should be selected using a function key provided in a mouse or a remote controller. Therefore, a user that does not know a method of browsing acoustic contents has a difficulty in selecting an acoustic content desired by him/her.

Therefore, unlike the method of browsing digital acoustic contents according to the related art, the necessity for a new method of browsing acoustic contents has been generated.

### SUMMARY

Additional aspects and/or advantages will be set forth in part in the description which follows and, in part, will be apparent from the description, or may be learned by practice of the embodiments.

Exemplary embodiments overcome the above disadvantages and other disadvantages not described above. Also, the embodiments are not required to overcome the disadvantages described above, and an exemplary embodiment of may not overcome any of the problems described above.

The embodiments provide an acoustic output device capable of guiding and outputting a position of an acoustic content selected depending on a scroll interaction, and a control method thereof.

According to an aspect, an acoustic output device includes: a speaker unit; a user interface unit providing a user interface region for browsing acoustic contents and a scroll user interface (UI) scrolled in the user interface region and guiding a position of an acoustic content selected depending on a scroll interaction in the user interface region to which all the acoustic contents are mapped; and a processor performing a control to decide or designate an acoustic content corresponding to a position of the scroll UI among all the acoustic contents mapped to the user interface region and output the decided acoustic content through the speaker unit.

The processor may map virtual acoustic content lists to the user interface region to decide the acoustic content corresponding to the position of the scroll UI among all the acoustic contents mapped to the user interface region.

The scroll UI may guide the position of the selected acoustic content in the virtual acoustic content lists mapped to the user interface region.

The speaker unit may include at least one speaker arranged in a preset direction and a cover unit provided on a front surface of the at least one speaker and covering the speaker, and the scroll UI may be implemented by a device that is physically movable in the preset direction on the cover unit.

The processor may project an image of information on the acoustic content corresponding to the position of the scroll UI on the cover unit using a projector included in the scroll UI.

The processor may project information related to an acoustic content corresponding to a changed position of the scroll UI on a region corresponding to the changed position of the scroll UI when the position of the scroll UI is changed depending on a user command.

The user interface unit may include a rail unit disposed in the preset direction below the speaker unit and implemented so that the scroll UI is physically movable, and the processor may determine an acoustic content corresponding to a position at which the scroll UI moving depending on a user command on the rail unit stops.

The acoustic output device may further include a sensor unit sensing a movement amount of the scroll UI and converting the movement amount into a digital signal, wherein the processor calculates a position of the scroll UI on the user interface region based on the converted digital signal and decides an acoustic content corresponding to the calculated position.

The processor may map one or more acoustic content lists to a vertical direction on the user interface region and map the respective acoustic contents in the acoustic content lists to a horizontal direction on the user interface region, and may decide an acoustic content list or an acoustic content in the acoustic content list corresponding to a region selected depending on a user interaction corresponding to the vertical direction or the horizontal direction.

According to another aspect, a control method of an acoustic output device including a user interface unit providing a user interface region for browsing acoustic contents and a scroll UI scrolled in the user interface region includes: guiding a position of an acoustic content selected depending on a scroll interaction in the user interface region to which all the acoustic contents are mapped; and deciding and outputting an acoustic content corresponding to a position of the scroll UI among all the acoustic contents mapped to the user interface region.

In the deciding and outputting of the acoustic content, virtual acoustic content lists may be mapped to the user interface region to decide the acoustic content corresponding to the position of the scroll UI among all the acoustic contents mapped to the user interface region.

In the guiding of the position of the acoustic content, the position of the selected acoustic content in the virtual acoustic content lists mapped to the user interface region may be guided.

The control method may further include projecting an image of information on the acoustic content corresponding to the position of the scroll UI on the user interface region using a projector included in the scroll UI.

The control method may further include projecting information related to an acoustic content corresponding to a changed position of the scroll UI on a region corresponding to the changed position of the scroll UI when the position of the scroll UI is changed depending on a user command.

The control method may further include sensing a movement amount of the scroll UI and converting the sensed movement amount of the scroll UI into a digital signal, wherein in the deciding and outputting of the acoustic content, the position of the scroll UI on the user interface region is calculated based on the converted digital signal and an acoustic content corresponding to the calculated position is decided.

In the deciding and outputting of the acoustic content, one or more acoustic content lists may be mapped to a vertical direction on the user interface region, the respective acoustic contents in the acoustic content lists may be mapped to a horizontal direction on the user interface region, and an acoustic content list or an acoustic content in the acoustic content list corresponding to a region selected depending on a user interaction corresponding to the vertical direction or the horizontal direction may be decided.

According to an aspect a speaker unit includes a speaker with a cover, a slidable interface unit slidable on the cover and a processor selecting and playing acoustic content via the speaker responsive to a position of the slidable interface unit on the cover.

The slidable interface unit may include a slidable device, a rail upon which the slidable device slides and a position detector sensor to detect the position.

The unit may further include a light projector to project, onto the cover, an image of the acoustic content to be selected based on the position.

A user may change the position by hand.

A user may change the position in two dimensions.

A user may change the position using a remote control device.

Additional and/or other aspects and advantages of the embodiments will be set forth in part in the description which follows and, in part, will be obvious from the description, or may be learned by practice of the embodiments.

### BRIEF DESCRIPTION OF THE DRAWINGS

The above and/or other aspects will be more apparent by describing certain exemplary embodiments with reference to the accompanying drawings, in which:

FIG. 1 is a view illustrating an implementation of an acoustic output device according to an exemplary embodiment;

FIG. 2A is a block view illustrating a configuration of the acoustic output device according to an exemplary embodiment;

FIG. 2B is a block diagram illustrating a detailed configuration of the acoustic output device illustrated in FIG. 2A;

FIG. 3 is a view illustrating software modules stored in a storing unit according to an exemplary embodiment;

FIGS. 4A and 4B are views for describing implementations of acoustic output devices according to various exemplary embodiments;

FIG. 5 is a view for describing a method of providing a graphic user interface (GUI) onto a cover unit according to an exemplary embodiment;

FIGS. 6A and 6B are views for describing a method of controlling a scroll state of a scroll GUI according to various exemplary embodiments;

FIGS. 7A and 7B are views describing a manipulation example of a user interface device according to an exemplary embodiment;

FIG. 8 is a view for describing an implementation of selecting acoustic content lists mapped to a user interface region according to an exemplary embodiment; and

FIG. 9 is a flow chart for describing a control method of an acoustic output device according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

Hereinafter, exemplary embodiments will be described in more detail with reference to the accompanying drawings. Further, when it is decided that a detailed description for the known function or configuration may obscure the gist, the detailed description therefor will be omitted. Further, the following terminologies are defined in consideration of the functions and may be construed in different ways by the intention of users and operators. Therefore, the definitions thereof should be construed based on the contents throughout the specification.

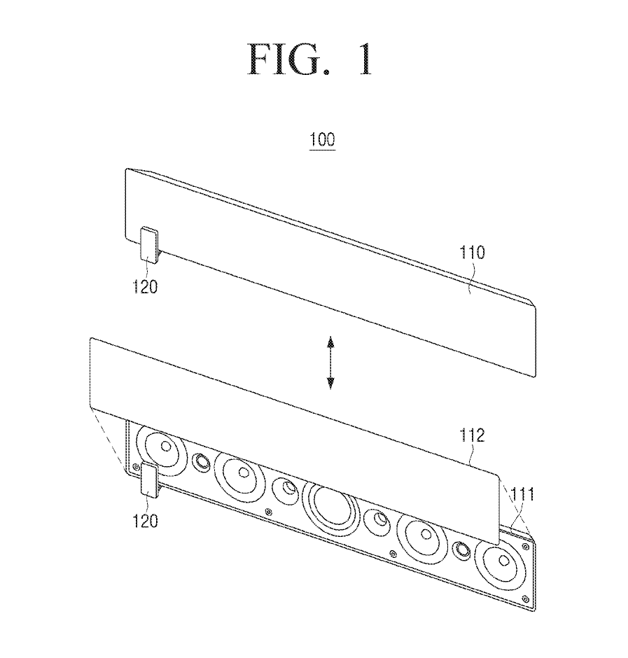

FIG. 1 is a view illustrating an implementation of an acoustic output device according to an exemplary embodiment. The acoustic output device 100 illustrated in FIG. 1 may be implemented in a wall-mounted form in which it may be attached onto a wall, a form in which it may stand on a stand, or the like, but is not limited thereto.

As illustrated in FIG. 1, the acoustic output device 100 may be implemented in a form in which it includes a speaker unit 110 and a user interface device 120.

As illustrated in FIG. 1, the speaker unit 110 may be implemented in a form in which it includes at least one speaker 111 (or a loudspeaker) arranged in a preset direction, for example, a horizontal direction and a cover 112 provided on a front surface of the at least one speaker 111 and covering the speaker 111.

The at least one speaker 111 may serve to convert an electrical pulse into a sound wave, and may be implemented in an electro-dynamic type, that is, a dynamic type, depending on a principle and a method of converting the electrical signal into the sound wave. However, the at least one speaker 111 is not limited to being implemented in the electro-dynamic type, but may be implemented in an electrostatic type, a dielectric type, a magneto-striction type, or the like.

In addition, the at least one speaker 111 may be implemented in a multi-way scheme of dividing a reproduction range into a low pitched sound, a middle pitched sound, and a high pitched sound and assigning the low pitched sound, the middle pitched sound, and the high pitched sound to speakers each appropriate for the low pitched sound, the middle pitched sound, and the high pitched sound. For example, in the case of a three-way scheme of assigning the low pitched sound, the middle pitched sound, and the high pitched sound to three speakers, the at least one speaker 111 may be implemented in a form in which it includes a high range speaker (tweeter) for reproducing a high frequency acoustic signal, a middle range speaker (midrange speaker) for reproducing a middle frequency acoustic signal, a low range speaker (or a woofer) for reproducing a low frequency acoustic signal, and the like.

The cover 112 is implemented by a thin grill made of a fiber or a metal, and serves to cover and protect the speaker. Here, the cover 112 may be attached to and detached from the speaker 111, and be used as a user interface region for browsing acoustic contents. A detailed description therefor will be provided below.

The user interface device 120 may be implemented as a device that is physically movable in a preset direction, for example, the horizontal direction in which the at least one speaker 111 is arranged, on the cover 112. However, the user interface device 120 is not limited thereto, but may also be implemented to be physically movable in a vertical direction in the case in which the speaker 110 is disposed in the vertical direction. In some cases, the user interface device 120 may also be implemented to be physically movable regardless of a direction in which the speaker is arranged.

Meanwhile, the acoustic output device 100 according to an exemplary embodiment may guide a position of an acoustic content selected depending on a scroll interaction of the user interface device 120 and output the selected acoustic content through the speaker 111. Hereinafter, exemplary embodiments will be described in detail with reference to the accompanying drawings. However, the above-mentioned implementation illustrates an example, and the acoustic output device according to an exemplary embodiment may be applied without being limited as long as it may guide the position of the acoustic content selected depending on the scroll interaction and output the selected acoustic content.

For example, also in the case in which a user terminal device guides the position of the acoustic content selected depending on the scroll interaction through a scroll graphic user interface (GUI) provided in a GUI form in and outputs the selected acoustic content, the spirit of the embodiments may be similarly applied.

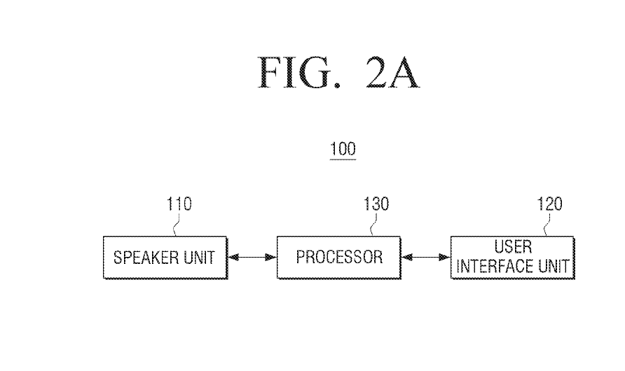

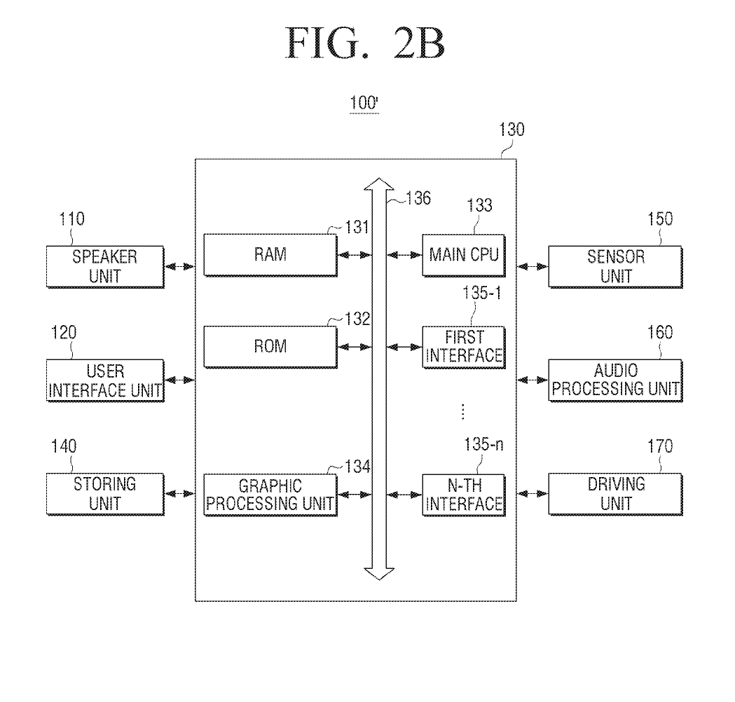

FIG. 2A is a block view illustrating a configuration of the acoustic output device according to an exemplary embodiment.

Referring to FIG. 2A, the acoustic output device 100 is configured to include a speaker unit 110, a user interface unit 120, and a processor 130.

The speaker unit 110 includes at least one speaker.

The user interface unit 120 provides a user interface region for browsing acoustic contents and a scroll UI (user interface) scrolled in the user interface region and guiding a position of an acoustic content selected depending on the scroll interaction in the user interface region to which all the acoustic contents are mapped. The scroll UI or movable/slidable interface device may move on a speaker cover in two dimensions or may be a graphical user interface projected onto the speaker cover.

Here, the scroll UI may be implemented by a physically movable device as described above with reference to FIG. 1. However, in the case in which the acoustic output device 100 is implemented as a user terminal device providing a display function, the scroll UI may also be provided in a GUI form. However, hereinafter, for convenience of explanation, the case in which the scroll UI is implemented by a physically movable device as described above with reference to FIG. 1 will be described.

The processor 130 may decide an acoustic content corresponding to a position of the scroll UI moving depending on the scroll interaction among all the acoustic contents mapped to the user interface region and output the decided acoustic content through the speaker unit 110. Here, the scroll interaction may be at least one of an interaction by a manual manipulation of a user, an interaction by a remote controller manipulation of the user, and an automatic interaction depending on a control of the processor 130.

In detail, the processor 130 may map virtual acoustic content lists to the user interface region to decide the acoustic content corresponding to the position of the scroll UI among all the acoustic contents mapped to the user interface region.

For example, when the virtual acoustic content lists include a total of thirty acoustic contents, the processor 130 may divide the user interface region into thirty regions and map one acoustic content to each of the thirty regions to map the total of thirty acoustic contents to the user interface region.

In addition, the processor 130 may decide an acoustic content corresponding to a position of the scroll UI moving depending on the scroll interaction among the thirty acoustic contents mapped to the user interface region.

Here, the scroll UI may guide a position of the selected acoustic content in the virtual acoustic content lists mapped to the user interface region.

That is, the scroll UI may display at which of the thirty acoustic contents mapped to the user interface region the scroll UI is positioned depending on the scroll interaction.

For example, the scroll UI moving depending on the scroll interaction may inform that an acoustic content corresponding to the position of the scroll UI is a twenty-seventh acoustic content of the thirty acoustic contents mapped to the user interface region. In order to decide the position of the scroll UI described above, a sensor unit sensing a movement amount of the scroll UI is required, and a detailed description for the sensor unit will be provided below.

Meanwhile, the speaker unit 110 may include at least one speaker 111 arranged in a preset direction and a cover unit 112 provided on a front surface of the at least one speaker and covering the speaker 111, as described above with reference to FIG. 1. In addition, the scroll UI may be implemented by a device 120 that is physically movable in the preset direction on the cover unit 112.

Therefore, the processor 130 may project an image of information on the acoustic content corresponding to the position of the scroll UI on the cover unit 112 using a projector included in the scroll UI. Here, the information on the acoustic content may include an album jacket image, a word, or the like, related to the acoustic content corresponding to the position of the scroll UI, and include an image preset by the user.

In addition, the processor 130 may project information related to an acoustic content corresponding to a changed position of the scroll UI on a region corresponding to the changed position of the scroll UI when the position of the scroll UI is changed depending on a user command.

In addition, when a control command for outputting the acoustic content is input by a user manipulation, the processor 130 may perform a control to output an acoustic content changed depending on the changed position of the scroll UI through the speaker unit 110.

For example, when the position of the scroll UI is changed to a third acoustic content depending on the user command in a state in which the scroll UI is positioned at the twenty-seventh acoustic content of the thirty acoustic contents mapped to the user interface region, the processor 130 may project an album jacket image, a word, or the like, related to the third acoustic content on a user interface region corresponding to the changed position of the scroll UI.

In addition, when a control command for outputting the third acoustic content is input by the user manipulation, the processor 130 may output the third acoustic content, which is an output changed from the twenty-seventh acoustic content that is currently being outputted.

Meanwhile, in the above-mentioned example, the processor 130, which generally is a component being in charge of a control of a device, may be called a central processing unit, a microprocessor, a controlling unit, or the like, control a general operation of the device, and be implemented by a system-on-chip (SoC).

FIG. 2B is a block diagram illustrating a detailed configuration of the acoustic output device illustrated in FIG. 2A. Referring to FIG. 2B, the acoustic output device 100′ is configured to include a speaker unit 110, a user interface unit 120, a processor 130, a storing unit 140, a sensor unit 150, an audio processing unit 160, and a driving unit 170. A detailed description for components overlapped with the components illustrated in FIG. 2A among components illustrated in FIG. 2B will be omitted.

The processor 130 generally controls an operation of the acoustic output device 100′.

In detail, the processor 130 includes a random access memory (RAM) 131, a read only memory (ROM) 132, a main central processing unit (CPU) 133, a graphic processing unit 134, first to n-th interfaces 135-1 to 135-n, and a bus 136.

The RAM 131, the ROM 132, the main CPU 133, the graphic processing unit 134, and the first to n-th interfaces 135-1 to 135-n may be connected to each other through the bus 136.

The first to n-th interfaces 135-1 to 135-n are connected to the above-mentioned various components. One of the interfaces may be a network interface connected to an external device through a network.

The main CPU 133 accesses the storing unit 140 to perform booting using an operating system stored in the storing unit 140. In addition, the main CPU 133 performs various operations using various programs, contents, data, or the like, stored in the storing unit 140.

An instruction set for booting a system, or the like, is stored in the ROM 132. When a turn-on command is input to supply power, the main CPU 133 copies the operating system stored in the storing unit 140 depending on an instruction stored in the ROM 132 to the RAM 131 and executes the operating system to boot the system. When the booting is completed, the main CPU 133 copies various application programs stored in the storing unit 140 to the RAM 131 and executes the application programs copied to the RAM 131 to perform various operations.

The graphic processing unit 134 renders a screen including various objects such as an icon, an image, a text, and the like, using a calculating unit (not illustrated) and a rendering unit (not illustrated). The calculating unit (not illustrated) calculates attribute values such as a coordinate value, a form, a size, a color, or the like, at which the respective objects are to be displayed depending on a layout of the screen based on a received control command. The rendering unit (not illustrated) renders various layouts of screens including the objects based on the attribute values calculated in the calculating unit (not illustrated). The screen rendered in the rending unit (not illustrated) may be projected on the user interface region corresponding to the position of the scroll UI through a projector included in the user interface unit 120.

Meanwhile, the operation of the processor 130 described above may be performed by a program stored in the storing unit 140.

The storing unit 140 stores various data such as an operating system software module for driving the acoustic output device 100′ and various multimedia contents therein.

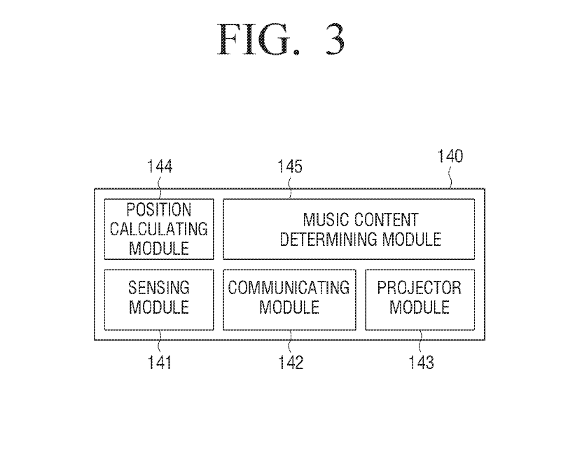

Particularly, the storing unit 140 may include various software modules for allowing the processor 130 to perform a control to decide the acoustic content corresponding to the position of the scroll UI among all the acoustic contents mapped to the user interface region and output the decided acoustic content through the speaker unit 110. This will be described in detail with reference to FIG. 3.

Meanwhile, the sensor unit 150 may sense a movement amount of the scroll UI and convert the sensed movement amount into a digital signal. As an example, the sensor unit 150 may be implemented by a rotary encoder, which is a sensor measuring a position of an object by a photoelectric method.

In detail, the rotary encoder is divided into an absolute rotary encoder and an incremental rotary encoder, and an example of the rotary encoder includes a totem-pole, an NPN open collector, a line driver, and the like, depending on a kind of output thereof. In addition, the rotary encoder is divided into a magnetic rotary encoder and an optical rotary encoder depending on a scheme thereof, and outputs a square wave pulse. Particularly, a scheme of measuring a position and a rotation speed of the rotary encoder includes an analog scheme and a digital scheme, and the digital scheme and the optical rotary encoder are mainly used. In the optical rotary encoder, when light emitted from a light emitting diode (LED) passes through slots of a rotary plate and a fixed plate and is then received in a photo transistor, the light may be changed into an electrical signal, and the electrical signal may be output as a square wave having a duty ratio of 50% through a comparator.

Therefore, the sensor unit 150 implemented by the rotary encoder may convert the movement amount of the scroll UI into the digital signal using the rotary plate rotating depending on the movement amount of the scroll UI, and the processor 130 may calculate a position of the scroll UI on the user interface region based on the converted digital signal and decide an acoustic content corresponding to the calculated position.

The audio processing unit 160 may process an audio signal so as to be appropriate for an output range of the speaker unit 110 and sound quality set by the user.

In addition, the driving unit 170 may drive the scroll UI so as to be physically movable. That is, the driving unit 170 may control movement of the scroll UI together with the sensor unit 150 described above.

Meanwhile, various software modules stored in the storing unit 140 will be described in detail.

FIG. 3 is a view illustrating software modules stored in a storing unit according to an exemplary embodiment.

Referring to FIG. 3, programs such as a sensing module 141, a communicating module 142, a projector module 143, a position calculating module 144, an acoustic content determining module 145, and the like, may be stored in the storing unit 140.

Meanwhile, the operation of the processor 130 described above may be performed by a program stored in the storing unit 140. Hereinafter, a detailed operation of the processor 130 using the programs stored in the storing unit 140 will be described in detail.

The sensing module 141 is a module collecting information from various sensors and analyzing and managing the collected information. The sensing module 141 may include a distance recognizing module, a touch recognizing module, a head direction recognizing module, a face recognizing module, an audio recognizing module, a motion recognizing module, a near field communication (NFC) recognizing module, and the like.

Particularly, the sensing module 141 according to an exemplary embodiment may serve to sense the movement amount of the scroll UI together with the sensor unit 150 implemented by the rotary encoder and convert the sensed movement amount into a digital signal.

In addition, the position calculating module 144 may serve to calculate a position of the scroll UI based on the converted digital signal. Therefore, the processor 130 may decide the position of the scroll UI moving depending on the scroll interaction using the sensing module 141 and based on the position calculating module 144 stored in the storing unit 140 and guide a position of the acoustic content corresponding to the position of the scroll UI.

Meanwhile, in the case of the scroll UI moving depending on a control signal received from a remote controller, the position calculating module 144 may detect position data from the received control signal, and the processor 130 may control the movement of the scroll UI through the driving unit 170 based on the calculated position data.

The communication module 142 is a module for performing communication with the outside. The communicating module 142 may include a phone module including a device module used for communication with an external device, a messaging module such as a messenger program, a short message service (SMS) & multimedia message service (MMS) program, an e-mail program, or the like, a call information aggregator program module, a VoIP module, or the like.

Particularly, the communicating module 142 according to an exemplary embodiment may receive an audio signal from the external device or receive a control signal of the scroll UI, a signal for selecting and reproducing the acoustic content, and the like, and process the received signals.

Meanwhile, the acoustic content determining module 145 may serve to determine an acoustic content corresponding to the position of the scroll UI calculated through the position calculating module 144. In detail, the acoustic content determining module 145 may determine what acoustic content corresponds to the position of the scroll UI depending on the scroll interaction for the scroll UI in the user interface region to which all the acoustic contents are mapped. Therefore, the processor 130 may perform a control to output the acoustic content determined using the acoustic content determining module 145 through the speaker unit 140.

In addition, the projector module 143 may serve to control a projector included in the scroll UI. For example, the projector module 143 may serve to process an image of information on the acoustic content determined through the acoustic content determining module 145 to project the image through the projector included in the scroll UI.

In addition, the projector module 143 may serve to decide a region corresponding to the changed position of the scroll UI in the user interface region, process an image of information on the acoustic content, and project the image on the decided region.

As described above, the processor 130 may decide and provide the acoustic content corresponding to the position of the scroll UI depending on the scroll interaction in the user interface region to which all the acoustic contents are mapped using various software modules stored in the storing unit 140.

Meanwhile, in the case in which the user UI is implemented by the physical user interface device 120 as illustrated in FIG. 1, a structure for deciding movement and a position of the user interface device 120 will be described in detail.

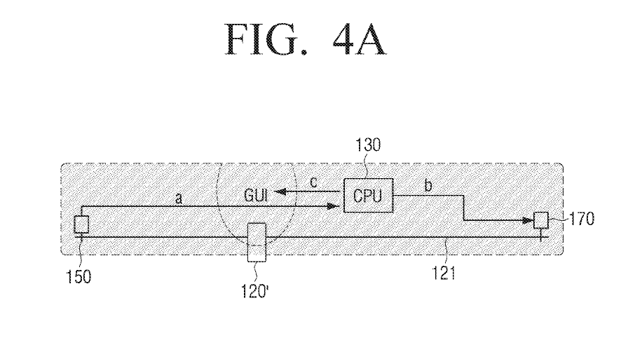

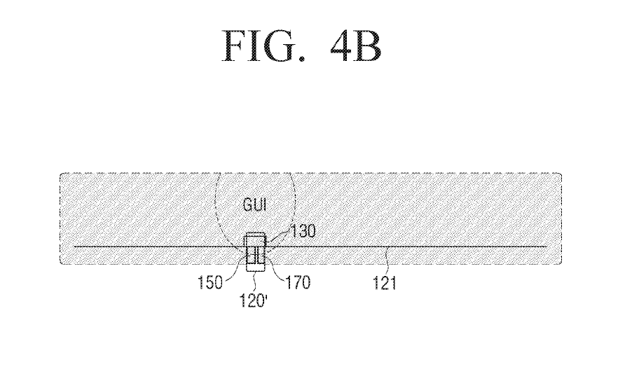

In detail, the user interface unit 120 may include a rail unit disposed in the preset direction below the speaker unit and implemented so that the scroll UI is physically movable, and the processor 130 may determine the acoustic content corresponding to the position at which the scroll UI moving depending on a user command on the rail unit stops. This will be described in detail with reference to FIGS. 4A and 4B.

FIGS. 4A and 4B are views for describing implementations of acoustic output devices according to various exemplary embodiments.

Referring to FIG. 4A, a user interface device 120′ by which a scroll UI is physically implemented and a rail unit 121 implemented so that the user interface device 120′ is physically movable are illustrated, and a sensor unit 150 deciding a position of the user interface device 120′ and a driving unit 170 driving the user interface device 120′ are illustrated.

Here, it is assumed that the sensor unit 150 is implemented by a rotary encoder and the driving unit 170 is implemented by a motor driving the rail unit 121.

Meanwhile, the rail unit 121 may include a rail and a timing belt required for the user interface device 120′ to physically move, and when the timing belt is operated by the movement of the user interface device 120′, a rotary plate of the rotary encoder 150 rotates simultaneously with the operation of the timing belt, such that a rotation amount of the rotary plate is converted into an electrical signal. The electrical signal converted as described above includes information on a position of the user interface device 120′ depending on a movement amount of the user interface device 120′.

When the rotary encoder 150 transmits the information a on the position of the user interface device 120′ to the processor 130, the processor 130 may project (c) an image of the information on the acoustic content in a GUI form on the user interface region through a projector included in the user interface device 120′ using the graphic processing unit 134 and the projector module 143 stored in the storing unit 140.

The driving unit 170 may drive the timing belt included in the rail unit 121 depending on the movement of the user interface device 120′. In addition, in the case in which the user interface device 120′ moves based on a control signal received by a remote controller, the processor 130 may detect position data from the received control signal and control (c) a motor included in the driving unit 170 based on the detected position data to operate the timing belt, thereby moving the user interface device 120′.

Meanwhile, although the case in which the processor 130, the sensor unit 150, the driving unit 170, and the user interface device 120′ are independently separated from each other, respectively, has been described by way of example in FIG. 4A, the processor 130, the sensor unit 150, and the driving unit 170 may also be implemented to be included together in the user interface device 120′.

Referring to FIG. 4B, it may be appreciated that the processor 130, the sensor unit 150, and the driving unit 170 are included together in the user interface device 120′, examples described with reference to FIG. 4A may be similarly applied as operations of the respective components.

Particularly, in the case in which the processor 130, the sensor unit 150, and the driving unit 170 are implemented to be included in the user interface device 120′, as illustrated in FIG. 4B, a structure of the user interface unit 120 is simplified, such that a thickness and a size of the acoustic output device 100 may be decreased.

Meanwhile, the rail unit 121 illustrated in FIGS. 4A and 4B may be designed to be modified depending on a size of the user interface region.

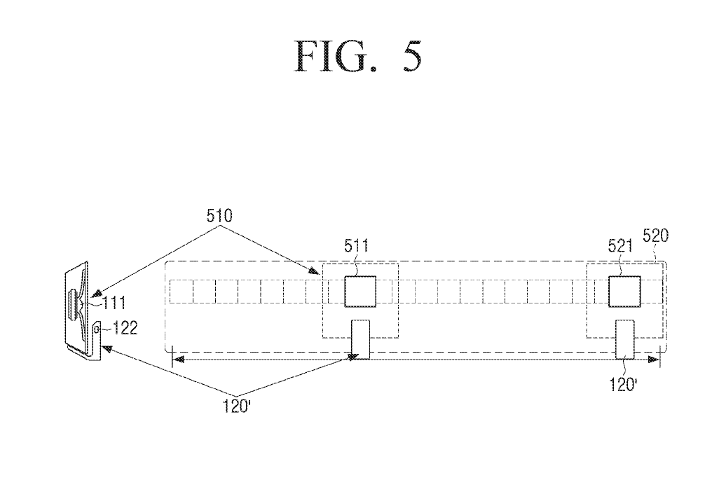

An implementation of the acoustic output device 100 has been described through a structure of changing a position of the user interface device 120′ with reference to FIGS. 4A and 4B, and a process in which the processor 130 projects information related to an acoustic content on the cover unit 112 will be described in detail with reference to FIG. 5.

FIG. 5 is a view for describing a method of providing a GUI onto a cover unit according to an exemplary embodiment.

Referring to FIG. 5, it may be appreciated that the speaker 111, the cover unit 112 disposed on the front surface of the speaker 111, and the user interface device 120′ are illustrated at the left of FIG. 5. Here, the cover unit 112 may be used as the user interface region for browsing the acoustic contents, and a projector 122 included in the user interface device 120′ may project an image on the user interface region.

In detail, it may be appreciated that the front surface of the cover unit 112, that is, the user interface region on which the image projected from the projector 122 is displayed, is illustrated at the right of FIG. 5 and the movable user interface device 120′ is positioned on a front surface of the user interface region.

In addition, the image projected from the projector 122 included in the user interface device 120′ may be displayed in a form of a GUI 511 in a region 510 corresponding to the position of the user interface device 120′ in the user interface region.

Here, the GUI 511 may include information on an album jacket image, a word, or the like, related to the acoustic content selected to correspond to the position of the user interface device 120′.

In addition, information on the previous song and the next song as well as the GUI 511 related to the currently selected acoustic content may be represented as a GUI in the region 510 corresponding to the position of the user interface device 120′.

Further, when a position of the user interface device 120′ is changed due to movement of the user interface device 120′ depending on a user manipulation or a control signal received from a remote controller, the processor 130 may decide an absolute coordinate of the user interface device 120′ based on a movement amount of the user interface device 120′ sensed by the sensor unit 150.

Here, the absolute coordinate of the user interface device 120′ means a position of the user interface device 120′ on the user interface region of FIG. 5, and the processor 130 may project an image of a GUI 521 related to an acoustic content selected to correspond to the changed position of the user interface device 120′ on a region 520 corresponding to the changed position of the user interface device 120′ decided as described above through the projector 122.

Meanwhile, although all the acoustic content lists are illustrated as dotted lines on the user interface region in FIG. 5, the acoustic content lists are not actually displayed on the user interface region, and an image of information on the acoustic contents may be projected and displayed on only regions 511 and 521 corresponding to the positions of the user interface device 120′.

In addition, the processor 130 may output the acoustic content selected to correspond to the position of the user interface device 120′ through the speaker unit 110 depending on an acoustic content output command input through one of the user interface device 120′ and the remote controller.

In addition, when the position of the user interface device 120′ is changed and the acoustic content output command is received through one of the user interface device 120′ and the remote controller, the processor 130 may output the acoustic content selected to correspond to the changed position.

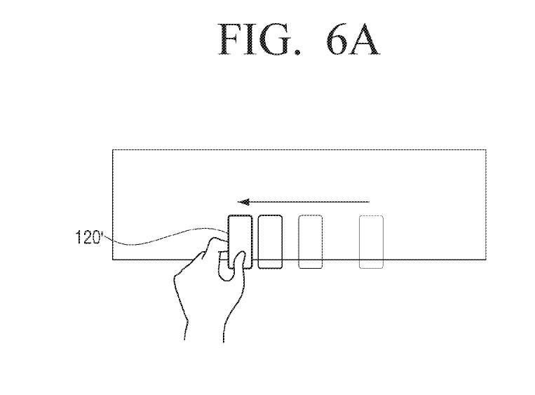

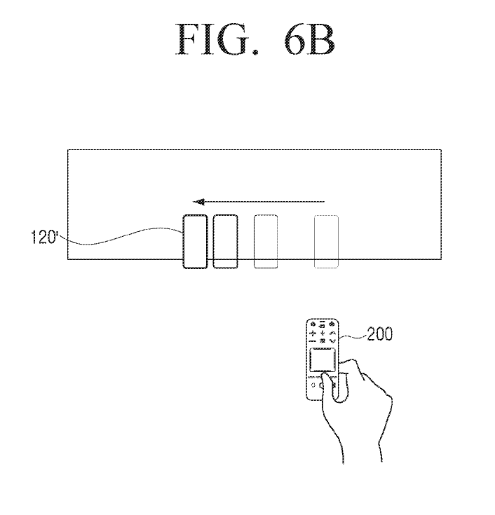

FIGS. 6A and 6B are views for describing a method of controlling a scroll state of a scroll GUI according to various exemplary embodiments of the present invention.

The scroll GUI 120′ may be manually controlled depending on a user interaction, as illustrated in FIG. 6A, or be automatically controlled by a remote controller 200, as illustrated in FIG. 6B.

For example, as illustrated in FIG. 6A, the user may directly hold the scroll GUI 120′ with his/her hand and then move the scroll GUI 120′ in a desired direction to perform a scroll interaction.

Alternatively, as illustrated in FIG. 6B, the user may control a scroll state of the scroll UI 120′ through a remote control (for example, a pointing input, a button input, a touch input through a touch pad, or the like) by the remote controller 200. In this case, the acoustic output device 100 may be implemented to perform communication with the remote controller 200. For example, a communicating module that may perform communication with the remote controller 200 may be included in the scroll UI 120′ itself or be included in the acoustic output device 100 outside the scroll UI 120′. In the latter case, the processor 130 may control a driving state of a motor (not illustrated) depending on a received remote control signal to control the scroll state of the scroll UI 120′.

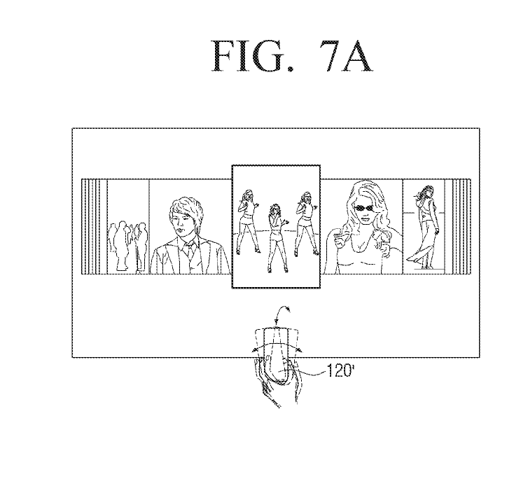

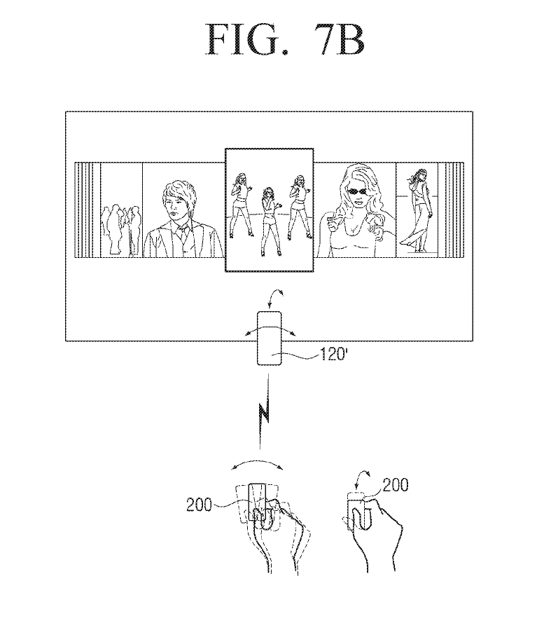

FIGS. 7A and 7B are views describing a manipulation example of a user interface device according to an exemplary embodiment.

Referring to FIG. 7A, information on an acoustic content selected to correspond to a position at which the user interface device 120′ stops depending on a scroll interaction in the user interface region may be provided at the position at which the user interface device 120′ stops, and information on acoustic contents corresponding to positions (the previous song and the next song) adjacent to the position at which the user interface device 120′ stops may also be provided in a preview form (for example, a form in which an image is unclearly projected).

In addition, the user may move the user interface device 120′ in left and right directions and front and rear directions to execute control functions such as acoustic selection, volume adjustment, menu adjustment, and the like.

Meanwhile, referring to FIG. 7B, it may be appreciated that the user does not directly manipulate the user interface device 120′, but may manipulate the user interface device 120′ using the remote controller 200.

For example, when the user shakes the remote controller 200 in the left and right directions, the user interface device 120′ may also move in the left and right directions, and the processor 130 may perform a function (for example, jacket image change, next song skip setting, or the like) corresponding to the movement of the user interface device 120′ in the left and right directions.

In addition, when the user shakes the user interface device 120′ in the front and rear directions using the remote controller 200, the user interface device 120′ may also move in the front and rear directions, and the processor 130 may perform a function (for example, a volume increase/decrease, a folder change, or the like) corresponding to the movement of the user interface device 120′ in the front and rear directions.

Meanwhile, although all the acoustic content lists may be mapped to one row on the user interface region, the case in which all the acoustic content lists are mapped to a plurality of rows and columns may be assumed.

In detail, the processor 130 may map one or more acoustic content lists to a vertical direction on the user interface region and map the respective acoustic contents in the acoustic content lists to a horizontal direction on the user interface region, and decide an acoustic content list or an acoustic content in the acoustic content list corresponding to a region selected depending on a user interaction corresponding to the vertical direction or the horizontal direction.

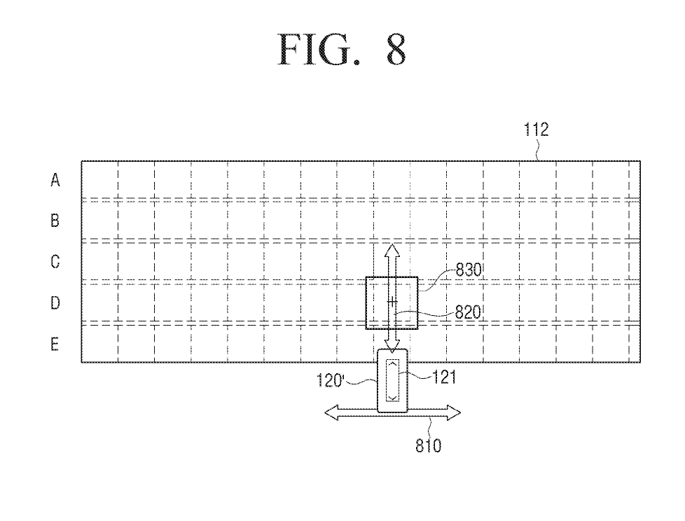

FIG. 8 is a view for describing an implementation of selecting acoustic content lists mapped to a user interface region according to an exemplary embodiment.

Referring to FIG. 8, virtual acoustic content lists are mapped to rows A, B, C, D, and E on the cover unit 112, and one or more acoustic contents included in the respective acoustic content lists are mapped to the respective rows.

As described above, the processor 130 may map the virtual acoustic content lists to the vertical direction on the user interface region to map different acoustic content lists to each row, and may map one or more acoustic contents included in the respective acoustic content lists to the horizontal direction.

In addition, the processor 130 may decide the acoustic content list or the acoustic content in the acoustic content list corresponding to the region selected depending on the user interaction corresponding to the vertical direction or the horizontal direction. For example, when the user interaction corresponding to the vertical direction is input depending on a user manipulation input through a touch panel 121 included in the user interface device 120′, the processor 130 may decide an acoustic content list corresponding to one of the rows A, B, C, D, and E mapped to the vertical direction 820 based on the user interaction corresponding to the vertical direction.

Further, the processor 130 may decide one of a plurality of acoustic contents mapped to the horizontal direction depending on the user interaction corresponding to the horizontal direction 810.

That is, the processor 130 may decide an acoustic content list corresponding to a row B of the rows A, B, C, D, and E mapped to the vertical direction 820 depending on the user interaction corresponding to the vertical direction, and decide a seventh acoustic content in the acoustic content list corresponding to the row B depending on the user interaction corresponding to the horizontal direction 810.

Although the case in which upward and downward scroll commands are input through the touch panel 121 included in the user interface device 120′ has been described by way of example in FIG. 8, the embodiments are not limited thereto. That is, the user may scroll the acoustic contents in the vertical direction 820 by directly bending the user interface device 120′ frontward and rearward or scroll the acoustic contents in the vertical direction 820 based on a control signal received through the remote controller 200.

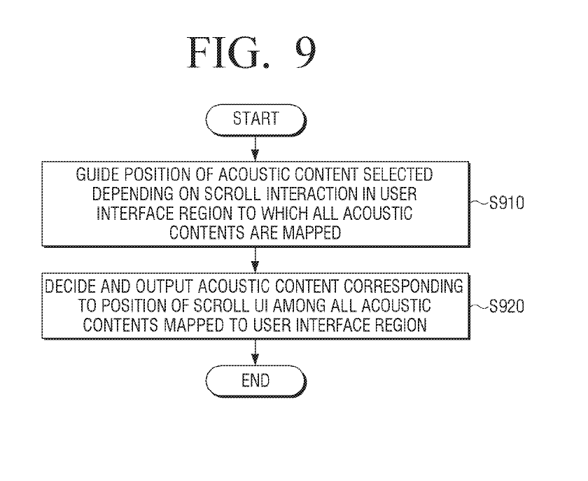

FIG. 9 is a flow chart for describing a control method of an acoustic output device according to an exemplary embodiment.

Referring to the control method illustrated in FIG. 9, in the control method of an acoustic output device including the user interface region for browsing the acoustic contents and the user interface unit controlling the scroll UI scrolled in the user interface region, the position of the acoustic content selected depending on the scroll interaction in the user interface region to which all the acoustic contents are mapped is guided (S910).

Then, the acoustic content corresponding to the position of the scroll UI among all the acoustic contents mapped to the user interface region is decided and output (S920).

In detail, in the deciding and outputting of the acoustic content, the virtual acoustic content lists may be mapped to the user interface region to decide the acoustic content corresponding to the position of the scroll UI among all the acoustic contents mapped to the user interface region.

In addition, in the guiding of the position of the acoustic content, the position of the selected acoustic content in the virtual acoustic content lists mapped to the user interface region may be guided.

In addition, the control method of an acoustic output device according to an exemplary embodiment may further include projecting the image of the information on the acoustic content corresponding to the position of the scroll UI on the user interface region using the projector included in the scroll UI.

In addition, the control method of an acoustic output device according to an exemplary embodiment may further include projecting the information related to the acoustic content corresponding to the changed position of the scroll UI on the region corresponding to the changed position of the scroll UI when the position of the scroll UI is changed depending on the user command.

Further, the control method of an acoustic output device according to an exemplary embodiment may further include sensing the movement amount of the scroll UI and converting the sensed movement amount of the scroll UI into the digital signal, and in the deciding and outputting of the acoustic content, the position of the scroll UI on the user interface region may be calculated based on the converted digital signal and the acoustic content corresponding to the calculated position may be decided.

In addition, in the deciding and outputting of the acoustic content, one or more acoustic content lists may be mapped to the vertical direction on the user interface region, the respective acoustic contents in the acoustic content lists may be mapped to the horizontal direction on the user interface region, and the acoustic content list or the acoustic content in the acoustic content list corresponding to a region selected depending on a user interaction corresponding to the vertical direction or the horizontal direction may be decided.

Meanwhile, a non-transitory computer readable medium in which a program sequentially performing the control method is stored may be provided.

As an example, a non-transitory computer readable medium in which a program is stored may be provided, wherein the program performs the guiding of the position of the acoustic content selected depending on the scroll interaction in the user interface region to which all the acoustic contents are mapped and deciding and outputting the acoustic content corresponding to the position of the scroll UI among all the acoustic contents mapped to the user interface region.

The non-transitory computer readable medium is not a medium that stores data therein for a while, such as a register, a cache, a memory, or the like, but means a medium that semi-permanently stores data therein and is readable by a device. In detail, various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

In addition, although a bus is not illustrated in the above block diagram illustrating a content source, an external speaker, and an acoustic output device, communication between the respective components in the content source, the external speaker, and the acoustic output device may also be made through the bus. In addition, a processor such as a central processing unit (CPU), a microprocessor, or the like, performing various processes described above may be further included in each device.

As set forth above, according to various exemplary embodiments, a position of a virtual acoustic content is displayed and outputted according to a position of a user interface device depending on a manipulation of a user, such that manipulation convenience of the user is increased.

Although exemplary embodiments have been illustrated and described hereinabove, the embodiments are not limited to the above-mentioned specific exemplary embodiments, but may be variously modified by those skilled in the art to which the embodiments pertain without departing from the scope and spirit of the embodiments as disclosed in the accompanying claims. These modifications should also be understood to fall within the scope of the embodiments.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. An acoustic output device, comprising:
a speaker unit;
a user interface unit providing a user interface region for browsing acoustic contents and a scroll user interface (UI) scrolled in the user interface region and designating a position of an acoustic content selected depending on a scroll interaction in the user interface region to which all the acoustic contents are mapped; and
a processor performing a control to designate an acoustic content corresponding to a position of the scroll UI among all the acoustic contents mapped to the user interface region and output a decided acoustic content through the speaker unit.

2. The acoustic output device as claimed in claim 1, wherein the processor maps virtual acoustic content lists to the user interface region to designate the acoustic content corresponding to a position of the scroll UI among all the acoustic contents mapped to the user interface region.

3. The acoustic output device as claimed in claim 2, wherein the scroll UI designates the position of the selected acoustic content in the virtual acoustic content lists mapped to the user interface region.

4. The acoustic output device as claimed in claim 1, wherein the speaker unit includes at least one speaker arranged in a preset direction and a cover unit provided on a front surface of the at least one speaker and covering the speaker, and
the scroll UI comprises a device that is physically movable in a preset direction on the cover unit.

5. The acoustic output device as claimed in claim 4, wherein the processor projects an image of information on the acoustic content corresponding to the position of the scroll UI on the cover unit using a projector included in the scroll UI.

6. The acoustic output device as claimed in claim 5, wherein the processor projects information related to an acoustic content corresponding to a changed position of the scroll UI on a region corresponding to the changed position of the scroll UI when the position of the scroll UI is changed depending on a user command.

7. The acoustic output device as claimed in claim 4, wherein the user interface unit includes a rail unit disposed in the preset direction below the speaker unit and implemented where the scroll UI is physically movable, and
the processor determines an acoustic content corresponding to the position at which the moving scroll UI stops on the rail unit depending on a user command.

8. The acoustic output device as claimed in claim 7, further comprising a sensor unit sensing a movement amount of the scroll UI and converting the movement amount into a digital signal,
wherein the processor calculates a position of the scroll UI on the user interface region based on the digital signal and designates an acoustic content corresponding to the calculated position.

9. The acoustic output device as claimed in claim 2, wherein the processor maps one or more acoustic content lists in a vertical direction on the user interface region and maps respective acoustic contents of the acoustic content lists in a horizontal direction on the user interface region, and designates one of an acoustic content list and an acoustic content in the acoustic content list corresponding to a region selected depending on a user interaction corresponding to one of the vertical direction and the horizontal direction.

10. A control method of an acoustic output device including a user interface unit providing a user interface region for browsing acoustic contents and a scroll UI (user interface) scrolled in the user interface region, the control method comprising:
determining a position of an acoustic content selected depending on a scroll interaction in the user interface region to which all the acoustic contents are mapped; and
designating and outputting an acoustic content corresponding to a position of the scroll UI among all the acoustic contents mapped to the user interface region.

11. The control method as claimed in claim 10, wherein in the designating and outputting of the acoustic content, virtual acoustic content lists are mapped to the user interface region to decide the acoustic content corresponding to the position of the scroll UI among all the acoustic contents mapped to the user interface region.

12. The control method as claimed in claim 11, wherein in the determining the position of the acoustic content, the position of the selected acoustic content in the virtual acoustic content lists mapped to the user interface region is determined.

13. The control method as claimed in claim 10, further comprising projecting an image of information of the acoustic content corresponding to the position of the scroll UI on the user interface region using a projector included in the scroll UI.

14. The control method as claimed in claim 13, further comprising projecting information related to an acoustic content corresponding to a changed position of the scroll UI on a region corresponding to the changed position of the scroll UI when the position of the scroll UI is changed depending on a user command.

15. The control method as claimed in claim 10, further comprising sensing a movement amount of the scroll UI and converting the movement amount of the scroll UI into a digital signal,
wherein in the designating and outputting of the acoustic content, the position of the scroll UI on the user interface region is calculated based on the digital signal and an acoustic content corresponding to the calculated position is decided.

16. The control method as claimed in claim 11, wherein in the designating and outputting of the acoustic content, one or more acoustic content lists are mapped in a vertical direction on the user interface region, the respective acoustic contents in the acoustic content lists are mapped in a horizontal direction on the user interface region, and one of an acoustic content list and an acoustic content in the acoustic content list corresponding to a region selected depending on a user interaction corresponding to one of the vertical direction and the horizontal direction is decided.

17. A speaker unit, comprising:
a speaker with a cover;
a slidable interface unit slidable on the cover; and
a processor selecting and playing acoustic content via the speaker responsive to a position of the slidable interface unit on the cover.

18. A unit as recited in claim 17, wherein the slidable interface unit comprises:
a slidable device;
a rail upon which the slidable device slides; and
a position detector sensor to detect the position.

19. A unit as recited in claim 17, further comprising a light projector to project, onto the cover, an image of the acoustic content to be selected based on the position.

20. A unit as recited in claim 17, wherein a user may change the position by hand.
